(19) United States
(12) Patent Application Publication
(10) Pub. No.: US 2023/0205401 A1
(43) Pub. Date: Jun. 29, 2023

(54) INTERFACE INTERACTION METHOD, APPARATUS, COMPUTER DEVICE AND STORAGE MEDIUM

(71) Applicant: Coocaa Network Technology Co., Ltd., Shenzhen (CN)

(72) Inventor: Xianhui ZENG, Shenzhen (CN)

(73) Assignee: Coocaa Network Technology Co., Ltd., Shenzhen (CN)

(21) Appl. No.: 17/999,962

(22) PCT Filed: May 19, 2021
(86) PCT No.: PCT/CN2021/094583

§ 371 Date: Nov. 28, 2022

(30) Foreign Application Priority Data
May 28, 2020 (CN) 202010469292.9

(51) Int. Cl. G06F 3/0483

(52) U.S. Cl. CPC G06F 3/0483

(57) ABSTRACT

Disclosed are an interface interaction method, an apparatus, a computer device, and a storage medium. The method comprises: a page switching instruction of a current page is received, a page identifier of a next page is carried by page switching instruction, the current page comprises a background layer and a content layer located above the background layer; page switching instruction is executed, and next page is displayed; and a first preset instruction configured to operate the next page is received when next page only comprises background layer, and the first preset instruction is executed. By presetting the interaction instruction configured to execute interaction of background layer, after switching the page to a page where background layer is located, when interaction instruction for the background layer is received, interaction instruction is executed to realize interaction for the background layer.

### REFERENCE TO RELATED APPLICATIONS

The present application is a National Phase Entry of PCT/CN2021/094583, filed May 19, 2021, which claims the benefit of Chinese patent application No. 202010469292.9, filed May 28, 2020 before the China National Intellectual Property Administration of the People's Republic of China, entitled “Interface Interaction Method, Apparatus, Computer Device and Storage Medium”, which is explicitly incorporated herein by reference in its entirety.

### TECHNICAL FIELD

The present disclosure generally relates to the technical field of smart TVs, and in particular to an interface interaction method, apparatus, computer device and storage medium.

### BACKGROUND OF THE INVENTION

At present, a large amount of contents are operated by most of common smart TV homepages in a form of graphics. If videos or pictures are used as TV background, it may only be played as a screensaver when the smart TV is in standby, but the homepage content may not be operated when the screensaver is playing. In order to solve this problem, a page interaction method in which a video or picture is used as a TV background in a smart TV homepage is proposed, so that the video or picture can be viewed while operating the homepage. When operating the homepage, the TV background only exists as a background, and the TV background may not be operated by user, thus failing to meet the user's demand for page interaction.

### SUMMARY OF THE INVENTION

In one aspect, the present disclosure relates to an interface interaction method, comprising:

receiving a page switching instruction of a current page, the page switching instruction carrying a page identifier of a next page, the current page comprising a background layer and a content layer located above the background layer;

executing the page switching instruction, displaying the next page; and

receiving a first preset instruction configured to operate the next page when the next page only comprises the background layer, and executing the first preset instruction.

In some embodiments, the method further comprises:

receiving a second preset instruction configured to operate the next page when the next page only comprises the content layer, and executing the second preset instruction, the content layer comprising at least one content classification module.

In some embodiments, the method further comprises:

receiving a third preset instruction configured to operate the content layer when the next page comprises the content layer and the background layer, and executing the third preset instruction, the content layer comprising at least one function classification module.

In some embodiments, when the next page only comprises the background layer, the first preset instruction comprises a background switching instruction, executing the first preset instruction comprises:

executing the background switching instruction, switching a background material in the background layer comprising at least two background materials.

In some embodiments, when the next page only comprises the background layer, the first preset instruction comprises a first control instruction, executing the first preset instruction comprises:

executing the first control instruction, and controlling the background material in the background layer.

In some embodiments, the method further comprises:

determining whether a first current active page is the current page, the first current active page being a page that is operated currently; and

receiving a return instruction when the first current active page is not the current page, and executing the return instruction configured to return the first current active page to the current page.

In some embodiments, the method further comprises:

determining whether a second current display page is a preset page, the second current display page being a page that is operated currently;

acquiring an execution time of a last operation instruction executed on the second current display page when the second current display page is the preset page; and

acquiring a current time, and when a time difference between the current time and the execution time is equal to a preset time difference, generating a first play instruction configured to play the background material, and executing the first play instruction.

In some embodiments, the background material comprises a plurality of recommending data, each of the recommending data carries at least one data tag, and each of the data tags corresponds to a function classification module.

In another aspect, the present disclosure relates to a smart TV interactive apparatus, comprising:

a switching instruction receiving module, configured to receive a page switching instruction of a current page, the page switching instruction carries a page identifier of a next page, the current page comprises a background layer and a content layer located above the background layer;

a switching instruction execution module, configured to execute the page switching instruction and display the next page; and

a first execution operation module, configured to receive a first preset instruction configured to operate the next page when the next page only comprises the background layer, and executing the first preset instruction.

In another aspect, the present disclosure relates to a computer device, comprising: a memory, a processor, and a computer program stored on the memory and capable of running on the processor, wherein the processor implements following method when executing the computer program:

receiving a page switching instruction of a current page, the page switching instruction carrying a page identifier of a next page, the current page comprising a background layer and a content layer located above the background layer;

executing the page switching instruction, and displaying the next page; and

receiving a first preset instruction configured to operate the next page when the next page only comprises the background layer, and executing the first preset instruction.

In yet another aspect, the present disclosure relates to a computer-readable storage medium with a computer program stored thereon, wherein the computer program implements following method when the computer program is executing by a processor:

receiving a page switching instruction of a current page, the page switching instruction carrying a page identifier of a next page, the current page comprising a background layer and a content layer located above the background layer;

executing the page switching instruction, and displaying the next page; and

receiving a first preset instruction configured to operate the next page when the next page only comprises the background layer, and executing the first preset instruction.

An interface interaction method, apparatus, computer device, and storage medium are disclosed, in some embodiments, the interface interaction method comprises: receiving a page switching instruction of a current page, the page switching instruction carrying a page identifier of a next page, the current page comprising a background layer and a content layer located above the background layer; executing the page switching instruction, and displaying the next page; and receiving a first preset instruction configured to operate the next page when the next page only comprises the background layer, and executing the first preset instruction. In some embodiments, by presetting the interaction instruction for executing the interaction of the background layer, after switching the page to the page where the background layer is located, when the interaction instruction for the background layer is received, the interaction instruction is executed to realize the interaction with the background layer.

### BRIEF DESCRIPTION OF THE DRAWINGS

The drawings herein are incorporated into the specification and constitute a part of the specification, show embodiments consistent with the present disclosure, and are used together with the specification to explain the principle of the present disclosure.

In order to more clearly explain the technical solutions in the embodiments of the present disclosure or the prior art, the following will briefly introduce the drawings required to be used in the description of the embodiments or the prior art, obviously, for those of ordinary skill in the art, in other words, other drawings can be acquired based on these drawings without creative labor.

FIG. 1 is an application environment diagram of an interface interaction method in an embodiment of the present disclosure;

FIG. 2 is a schematic flowchart of an interface interaction method in an embodiment of the present disclosure;

FIG. 3 is a schematic diagram of the effect of the main page in an embodiment of the present disclosure;

FIG. 4 is a schematic diagram of the effect of a content expansion page in an embodiment of the present disclosure;

FIG. 5 is a schematic diagram of the effect of a content expansion page in an embodiment of the present disclosure;

FIG. 6 is a schematic diagram of the effect of a background material page in an embodiment of the present disclosure;

FIG. 7 is a schematic diagram of the effect of playing an audio-visual in an embodiment of the present disclosure;

FIG. 8 is a structural block diagram of a smart TV interactive apparatus in an embodiment of the present disclosure; and

FIG. 9 is an internal structure diagram of a computer device in an embodiment of the present disclosure.

### DETAILED DESCRIPTION

In order to make the objectives, technical solutions, and advantages of the embodiments of the present disclosure clearer, the technical solutions in the embodiments of the present disclosure will be described clearly and completely with reference to the accompanying drawings in the embodiments of the present disclosure, obviously, the described embodiments are a part of the embodiments of the present disclosure, but not all of the embodiments. Based on the embodiments in the present disclosure, all other embodiments acquired by those of ordinary skill in the art without creative work shall fall within the protection scope of the present disclosure.

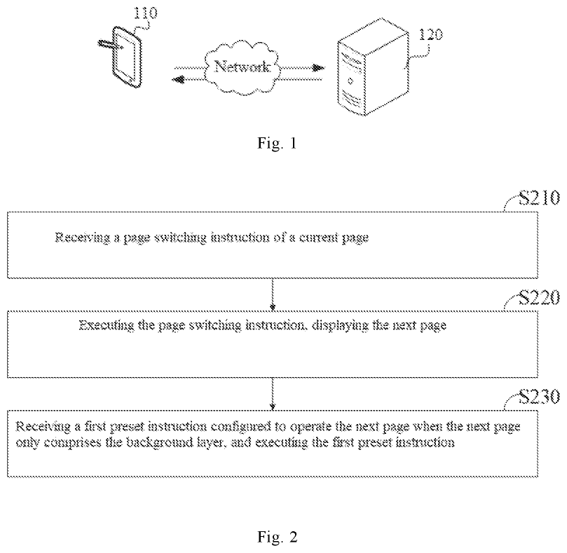

FIG. 1 shows an application environment diagram of an interface interaction method in an embodiment of the present disclosure. Referring to FIG. 1, the interface interaction method is applied to a smart TV interaction system. The smart TV interactive system comprises a terminal 110 and a server 120. The terminal 110 and server 120 are connected through network. The terminal 110 may be a desktop terminal or a mobile terminal, and mobile terminal may be at least one of a mobile phone, a tablet computer, a notebook computer, etc., and desktop terminal may be at least one of a smart TV or a desktop computer. The server 120 may be implemented as an independent server or a server cluster composed of multiple servers.

In some embodiments, FIG. 2 shows a schematic flowchart of an interface interaction method in an embodiment of the present disclosure. Referring to FIG. 2, an interface interaction method is provided. In this embodiment, method mainly applied to the terminal 110 in FIG. 1 is taken as an example, the interface interaction method comprises steps 210-230:

S210, a page switching instruction of a current page is received;

S220, a page switching instruction is executed, and a next page is displayed; and

S230, a first preset instruction configured to operate the next page is received when a next page only comprises a background layer, and a first preset instruction is executed.

In some embodiments, a page switching instruction is generated by pressing a virtual button or a mechanical button of the control device or sliding the virtual touch screen by a user, the control device is arranged independently of a terminal, such as a remote controller; and the control device maybe also arranged inside the terminal. Page identifier of a next page is carried by page switching instruction, current page comprises a background layer and a content layer, content layer is located above the background layer, page switching instruction comprises a switching selection instruction and an entry selection instruction, page identifier of the next page is carried by page switching instruction, page identifier comprises a page layout and a page content, and the page content corresponds to the page layout, page layout comprises: a background layer and a content layer in the first case, only a background layer in the second case, and only a content layer in the third case. Content layer is placed above background layer, content layer comprises at least one classification module, and background layer comprises at least one background material. In the first case that page content corresponds to the page layout, a background material of the background layer and a classification module of the content layer are comprised. In the second case that page content corresponds to the page layout, only a background material of the background layer is comprised. In the third case that page content corresponds to page layout, only a data information of the target classification module in the content layer is comprised.

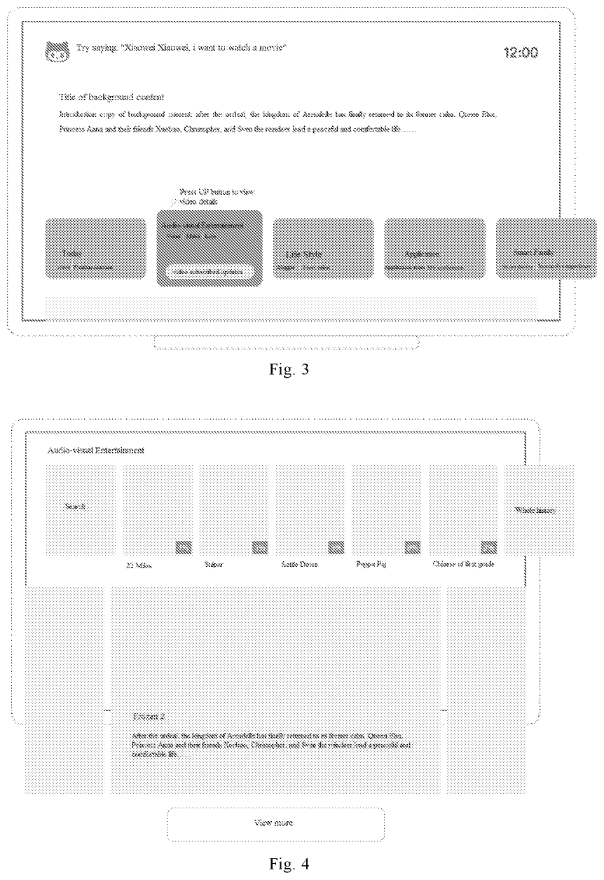

Referring to FIG. 3, which shows a schematic diagram of the effect of main page in an embodiment of the present disclosure. “Today”, “Audio-visual Entertainment”, “Lifestyle”, “Application”, “Smart Family”, etc., are all function classification modules in figure, when selecting “Audio-visual Entertainment” by focus as a target function classification module in FIG. 3, at this time, background material of background layer comprises audio-visual videos or pictures recommended corresponding to “Audio-visual Entertainment”, background layer covers entire display interface, and content layer is superimposed above background layer.

In some embodiments, a corresponding page switching instruction is generated through pressing different buttons of the remote controller by user. Corresponding relationship between buttons and page switching instructions may be customized according to the situation.

In some embodiments, page layout and page content of the next page are determined according to page switching instruction and page identifier of next page carried by the page switching instruction, and next page is displayed.

In some embodiments, page switching instruction is generated by pressing the UP button of the remote controller by user, which controls the display page to switch from main page to background material page. Pressing the DOWN button of remote controller may control display page to switch from main page to content expansion page. Pressing the LEFT and RIGHT buttons of the remote controller may move the focus to the right or left. Pressing the CENTER button of the remote controller may determine module selected by the focus and expand the detailed information of the module, audio-visual video will be played when the audio-visual video is selected by focus.

In some embodiments, when it is determined that only background layer is comprised according to page layout of next page, current page is switched to next page, that is, main page is switched to a page where the background material is located, that is, a background material page, when first preset instruction configured to operate background material is received in this page, first preset instruction is executed to realize the interactive operation on the background material page.

In some embodiments, FIG. 4 shows a schematic diagram of the effect of a content expansion page in an embodiment of the present disclosure. Referring to FIG. 4, when next page only comprises a content layer, a second preset instruction configured to operate the next page is received, second preset instruction is executed, content layer comprises at least one content classification module.

In some embodiments, when next page only comprises a content layer, that is, main page is switched to content expansion page, target function classification module is determined from function classification module of content layer in main page, and target function classification module is entered according to page switching instruction, function classification module comprises at least one content classification module, and page content of next page only comprises data information of target classification module, that is, content expansion page comprises at least one content classification module. A second preset instruction for the next page is received, the second preset instruction comprises a second switching instruction, a second entry instruction, and a second return instruction.

Referring to FIG. 3 and FIG. 4, function classification module of “Audio-visual Entertainment” is selected by focus from main page of smart TV as a target function classification module, at this time, page switching instruction is an entry selection instruction, page switching instruction is executed, and target function classification module of “Audio-visual Entertainment” is expanded, content expansion page is entered, at this time, the content expansion page comprises a content classification module related to “Audio-visual Entertainment”, and when a second preset instruction of controlling content expansion page is received again, a second preset instruction is executed, the second preset instruction comprises a second switching instruction, a second entry instruction, and a second return instruction. If selecting “Sniper” by focus in the next page as a target content classification module, the focus is switched to other content classification modules according to the second switching instruction when the second preset instruction is second switching instruction, that is, the focus is switched to “22 miles” or “Settle Down” or “Frozen 2”; when the second preset instruction is a second entry instruction, the second entry instruction is executed and the target content classification module is entered, that is, “Sniper” is played; and when the second preset instruction is a second return instruction, a second return instruction is executed, the next page is returned to current page, that is, content expansion page is returned to main page.

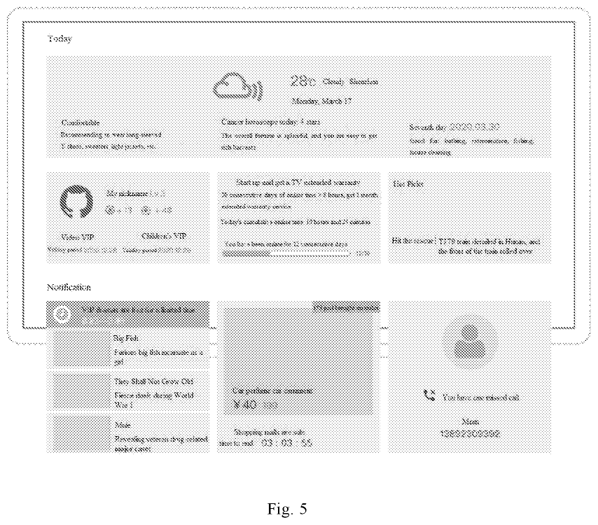

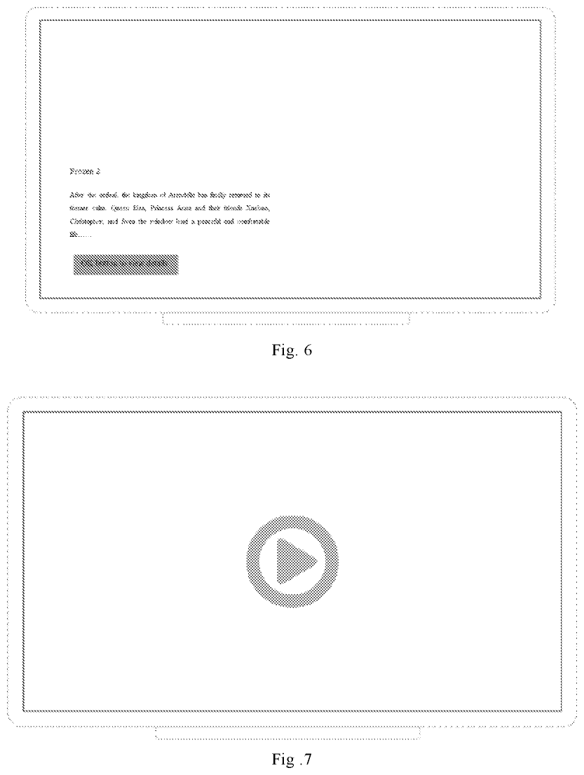

FIG. 5 shows a schematic diagram of the effect of a content expansion page in an embodiment of the present disclosure. Target function classification module is “Today”. Content expansion page comprises data information related to “Today”, such as today's weather information, account information, message notification information, etc.

In some embodiments, when next page comprises a content layer and a background layer, a third preset instruction configured to operate the content layer is received, and content layer comprises at least one function classification module, the third preset instruction is executed.

In some embodiments, when next page comprises a content layer and a background layer, that is, current page is switched to next page, only other function classification modules of content layer of main page that selected by focus is regarded as target function classification module, background material matched with the target function classification module is acquired in background layer, and background material matched with target function classification module is displayed. A third preset instruction for the next page is received, at this time, next page still stays on main page, third preset instruction comprises a third switching instruction, a fourth switching instruction, and a third entry instruction, when the third preset instruction is third switching instruction, the third switching instruction is executed, main page is switched to background material page; when the third preset instruction is the fourth switching instruction, the fourth switching instruction is executed, target function classification module of main page selected by focus is switched; and when the third preset instruction is a third entry instruction, the third entry instruction is executed, main page is switched to the content expansion page corresponding to the target function classification module selected by the focus.

Referring to FIG. 3, when unction classification module “Today” of main page selected by focus is regarded as target function classification module, a background material matched with “Today” is acquired, at this time, background material of background layer comprises today's headline information video and weather GIF, account usage information, etc., multiple background materials for user's choice may be selected as a background of the main page, or multiple background materials are played sequentially or randomly. When the focus on main page is switched from “Today” to “Audio-visual Entertainment”, that is, current page is switched to next page, and background material matched with “Audio-visual Entertainment” is acquired, at this time, background material comprises promotional images, promotional videos or highlight videos of multiple film and television works, background material matched with “Audio-visual Entertainment” is played by background layer. At this time, next page is main page, and target function classification module selected by focus is “Audio-visual Entertainment”; when third switching instruction is received, background material page matched with the “Audio-visual Entertainment” is switched to; when the fourth switching instruction is received, the fourth switching instruction is executed, “Lifestyle” function classification module is switched as new target function classification module, and background material of background layer will be switched synchronously with the target function classification module; and when the third entry instruction is received , the third entry instruction is executed, content expansion page of “Audio-visual Entertainment” is entered.

In some embodiments, when next page only comprises a background layer, the first preset instruction comprises a background switching instruction, background switching instruction is executed, background material of background layer is switched, background layer comprises at least two background materials.

In some embodiments, main page is switched to next page according to page switching instruction, and next page only comprises background layer, that is, main page is switched to background material page, background switching instruction for background material page is received, and background material selected by focus is switched, that is, background material may be selected as background of main page by user according to their preferences and needs.

In some embodiments, FIG. 6 shows a schematic diagram of the effect of background material page in an embodiment of the present disclosure. Referring to FIG. 6, when next page only comprises background layer, the first control instruction is executed, and background material in background layer is controlled.

In some embodiments, main page is switched to background material page, a first control instruction for the background material page is received, and background material selected by focus in the background material page is controlled, the background material is a recommending data corresponding to the function classification module, that is, background material corresponding to “Audio-visual Entertainment” comprises multiple audio-visual pictures or audio-visual videos recommended; background material corresponding to “Today” comprises news videos, weather forecasts or account usage data information recommended, etc.; background material corresponding to “Life Style” comprises bloggers video or other short videos recommended; and background material corresponding to “Application” comprises application software pictures recommended. Each of the function classification modules correspond to a data label, and each type of data carries at least one data label.

The first control instruction is executed, that is, the recommending data that carries data tag corresponding to target function classification module is controlled. For example, when target classification function module is “Audio-visual Entertainment”, when main page is switched to background material page of playing, a picture is displayed in background material page, and the first control instruction is executed, which may be to play audio-visual video corresponding to picture displayed, or to collect a picture displayed corresponding to audio-visual video; and when target classification function module is “Today”, first control instruction is executed, which may be to play today's headline video, weather forecast dynamic graph, or viewing account usage data information, etc. When target classification function module is “Application”, first control instruction is executed, which may be to view the detailed information of application software recommended, to download application software, to purchase application software, to add to shopping cart and so on.

In some embodiments, FIG. 7 shows a schematic diagram of the effect of playing audio-visual videos in an embodiment of the present disclosure. Referring to FIG. 6 and FIG. 7, that is, a page switching to background material page from main page only displays audio-visual pictures, when the first control instruction is received, audio-visual video matched with audio-visual picture is acquired, and audio-visual video is played; if audio-visual video matched with the audio-visual picture may not be acquired, there is no any page change when first control instruction is executed.

In some embodiments, whether the first current active page is a current page is determined, and the first current active page is a page that may be operated currently; and when the first current active page is not current page, return instruction is received, and return instruction is executed, return instruction is configured to return to current page from first current active page.

In some embodiments, whether the first current active page is a main page is determined, the first current active page is a page that may be currently operated, and when the first current active page is not main page, a return instruction is received and the return instruction is executed, returning to the main page, that is, quickly returning to the main page by executing the return instruction.

In some embodiments, the third current active page is a page that may be currently operated, and when cancel instruction is received by the third currently active page, cancel instruction is executed, that is, previous page of the third current active page is returned.

In some embodiments, whether the second current display page is a preset page is determined, and the second current display page is a page that may be currently operated; when the second current display page is a preset page, execution time of last operation instruction executed in the second current display page is acquired; and current time is acquired, when time difference between current time and execution time is equal to the preset time difference, a first playing instruction configured to play the background material is generated, and the first playing instruction is executed.

In some embodiments, preset page comprises a main page, a content expansion page, and a configuration page. when the second current display page is a preset page, execution time of the last operation instruction executed on the second current display page is acquired; and current time is acquired, when time difference between current time and execution time is equal to the preset time difference, that is, retention time that the second current display page does not receive any operation instructions is acquired, when retention time reaches an preset time, the first playing instruction is generated, the first play instruction is executed, background material matched with the second current display page is played, which can be automatically played in order, randomly played in the playing order, or looped or multiple background materials.

FIG. 2 shows a schematic flowchart of an interface interaction method in an embodiment of the present disclosure. It should be understood that although the various steps in the flowchart of FIG. 2 are displayed in sequence as indicated by the arrows, these steps are not necessarily performed in sequence in the order indicated by the arrows. Unless specifically stated in this article, the execution of these steps is not strictly limited in order, and these steps can be executed in other orders. Moreover, at least part of the steps in FIG. 2 may include multiple sub-steps or multiple stages, these sub-steps or stages are not necessarily executed at the same time, but can be executed at different times, the execution of these sub-steps or stages is not necessarily performed sequentially, but may be performed alternately or alternately with other steps or at least a part of sub-steps or stages of other steps.

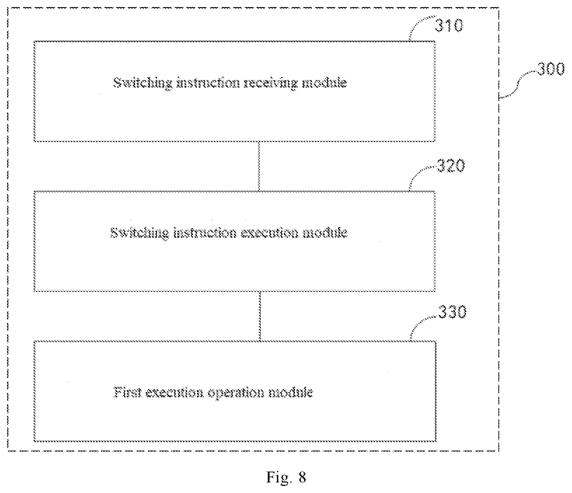

In some embodiments, as shown in FIG. 8, a smart TV interaction apparatus 300 is provided, which comprises:

a switching instruction receiving module 310 configured to receive a page switching instruction of a current page, page switching instruction carries a page identifier of a next page, current page comprises a background layer and a content layer, and content layer is located above the background layer;

a switching instruction execution module 320 configured to execute page switching instruction and display next page; and

a first execution operation module 330 configured to receive a first preset instruction configured to operate next page when the next page only comprises background layer, and the first preset instruction is executed.

In some embodiments, apparatus further comprises:

a second execution operation module configured to receive a second preset instruction configured to operate next page when the next page only comprises content layer, and content layer comprises at least one content classification module, second preset instruction is executed.

In some embodiments, apparatus further comprises:

a third execution operation module configured to receive a third preset instruction configured to operate content layer when next page comprises a content layer and a background layer, content layer comprises at least one function classification module, the third preset instruction is executed.

In some embodiments, when next page only comprises a background layer, the first preset instruction comprises a background switching instruction, and the first execution operation module 330 comprises:

a background switching unit configured to execute a background switching instruction, and to switch background material in background layer, background layer comprises at least two background materials.

In some embodiments, when next page only comprises a background layer, a first preset instruction comprises a first control instruction, and the first execution operation module 330 further comprises:

a playing unit configured to execute the first control instruction, and to control background material in the background layer.

In some embodiments, apparatus further comprises:

a first page determination module configured to determine whether the first current active page is the current page, and the first current active page is a page that may be currently operated; and

a return execution module configured to receive a return instruction and execute return instruction when the first current active page is not current page, return instruction is configured to return to current page from the first current active page.

In some embodiments, apparatus further comprises:

a second page determination module configured to determine whether the second current display page is a preset page, and the second current display page is a page that can be currently operated;

a time acquisition module configured to acquire execution time of last operation instruction executed on the second current display page when the second current display page is preset page; and

a background playing module configured to acquire current time, and when time difference between current time and execution time is equal to preset time difference, a first play instruction configured to play background material is generated, and the first play instruction is executed.

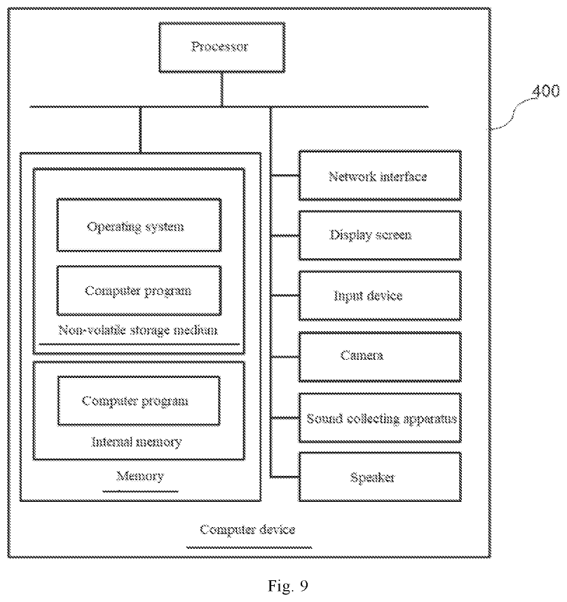

FIG. 9 shows an internal structure diagram of a computer device 400 in an embodiment of the present disclosure. Computer device 400 may be terminal 110 (or server 120) in FIG. 1. As shown in FIG. 9, computer device 400 comprises a processor, a memory, a network interface, an input device, and a display screen connected through a system bus. Among them, the memory comprises a non-volatile storage medium and an internal memory. The non-volatile storage medium of the computer device stores an operating system and may also store a computer program, when computer program is executed by the processor, an interface interaction method may be implemented by the processor. The internal memory may also store a computer program, and when the computer program is executed by the processor, the interface interaction method can be executed by the processor. The display screen of the computer equipment can be a liquid crystal display screen or an electronic ink display screen, the input apparatus of the computer device may be the touch layer covered on the display screen, the keys, trackball, or touchpad set on the shell of the computer equipment, or an external keyboard, touchpad or mouse, etc.

Those skilled in the art can understand that the structure shown in FIG. 9 is only a block diagram of part of the structure related to the solution of the present disclosure, and does not constitute a limitation on the computer device to which the solution of the present disclosure is applied, the specific computer device may include more or fewer parts than shown in the figure, or combining some parts, or having a different arrangement of parts.

In some embodiments, a smart TV interaction apparatus provided in the present disclosure may be implemented in form of a computer program, and computer program may be run on computer device as shown in FIG. 9. The memory of the computer device can store various program modules that make up the smart TV interactive apparatus, the various program modules comprise switching instruction receiving module 310, switching instruction execution module 320, and first executing operation module 330 shown in FIG. 8. The interface interaction method of each embodiment of the present disclosure described in this specification is executed by the processor caused by computer program composed of each program module.

Page switching instruction of receiving current page may be executed through computer device shown in FIG. 9 by the switching instruction receiving module 310 in smart TV interactive apparatus shown in FIG. 8, page switching instruction carries a page identifier of next page, and current page comprises background layer and content layer, content layer is located above the background layer. The page switching instruction may be executed by the switching instruction execution module 320 through computer device, and next page is displayed. The first preset instruction configured to operate the next page is received when the next page only comprises the background layer, and a first preset instruction is executed by the first execution operation module 330 through the computer device.

In some embodiments, a computer device is provided, which comprises a memory, a processor, and a computer program stored in the memory and can be run on the processor, the computer program is executed by processor to implement the following steps: a page switching instruction of the current page is received, page identifier of the next page is carried by the page switching instruction, current page comprises a background layer and a content layer, and content layer is above the background layer; page switching instruction is executed, next page is displayed; and when the next page only comprises the background layer, a first preset instruction configured to operate the next page is received, and the first preset instruction is executed.

In some embodiments, the following steps are further implemented when the processor is executed by the computer program: when the next page only comprises a content layer, a second preset instruction configured to operate the next page is received, content layer comprises at least one content classification module, the second preset instruction is executed.

In some embodiments, the following steps are further implemented when the processor is executed by the computer program: when the next page comprises a content layer and a background layer, a third preset instruction configured to operate the content layer is received, content layer comprises at least one function classification module, the third preset instruction is executed.

In some embodiments, the following steps are further implemented when the processor is executed by the computer program: when a next page only comprises the background layer, the first preset instruction comprises a background switching instruction, background switching instruction is executed, and background material in the background layer is switched, the background layer comprises at least two background materials.

In some embodiments, following steps are further implemented when the processor is executed by the computer program: when next page only comprises the background layer, the first preset instruction comprises a first control instruction, first control instruction is executed, and background in the background layer material is controlled.

In some embodiments, the following steps are further implemented when the processor is executed by the computer program: whether the first currently active page is a current page is determined, and the first current active page is current operable page; and when the first current active page is not current page, return instruction is received, and return instruction is executed, the return instruction is configured to return to current page from the first current active page.

In some embodiments, the following steps are further implemented when processor is executed by computer program: whether the second current display page is a preset page is determined, the second current display page is a page that can be currently operated; when the second current display page is a preset page when page is arranged, execution time of the last operation instruction executed on the second current display page is acquired; and current time is acquired, when time difference between current time and execution time is equal to preset time difference, the first time configured to play background material is generated, and the first play instruction is executed.

In some embodiments, a computer-readable storage medium is provided, on which a computer program is stored, the following steps are implemented when the processor is executed by the computer program: a page switching instruction of the current page is received, and page identifier of the next page is carried by page switching instruction, current page comprises a background layer and a content layer, the content layer is above the background layer; page switching instruction is executed, and next page is displayed; and when the next page only comprises the background layer, the first preset instruction configured to operate the next page is received, and the first preset instruction is executed.

In some embodiments, the following steps are further implemented when the processor is executed by the computer program: when the next page only comprises a content layer, a second preset instruction configured to operate the next page is received, and the content layer comprises at least one content classification module, and the second preset instruction is executed.

In some embodiments, the following steps are further implemented when the processor is executed by the computer program: when the next page comprises a content layer and a background layer, a third preset instruction configured to operate the content layer is received, the content layer comprises at least one function classification module, the third preset instruction is executed.

In some embodiments, the following steps are further implemented when the processor is executed by the computer program: when the next page only comprises a background layer, the first preset instruction comprises a background switch instruction, background switch instruction is executed, and background material in the background layer is switched, background layer comprises at least two background materials.

In some embodiments, the following steps are further implemented when the processor is executed by the computer program: when the next page only comprises the background layer, the first preset instruction comprises the first control instruction, the first control instruction is executed, and background material of background layer is controlled.

In some embodiments, the following steps are further implemented when the processor is executed by the computer program: whether the first current active page is the current page is determined, the first current active page is a page that may be currently operated; and when the first current active page is not current page, return instruction is received, and the return instruction is executed, return instruction is configured to return to current page from the first current active page.

In some embodiments, the following steps are further implemented when the processor is executed by the computer program: whether the second current display page is a preset page is determined, the second current display page is a page that can be currently operated; when the second current display page is preset page, execution time of the last operation instruction executed on the second current display page is acquired; and current time is acquired, when time difference between the current time and the execution time is equal to preset time difference, a first play instruction configured to play the background material is generated, and the first play instruction is executed.

Those of ordinary skill in the art can understand that all or part of the processes in the methods of the above embodiments can be implemented by computer programs instructing relevant hardware, and the programs can be stored in a non-volatile computer readable storage medium, when the program is executed, it may include the processes of the above-mentioned method embodiments. Wherein, any reference to memory, storage, database or other media used in the various embodiments provided in the present disclosure may include non-volatile and/or volatile memory. Non-volatile memory may include read only memory (ROM), programmable ROM (PROM), electrically programmable ROM (EPROM), electrically erasable programmable ROM (EEPROM), or flash memory. Volatile memory may comprise random access memory (RAM) or external cache memory. As an illustration and not a limitation, RAM is available in many forms, such as static RAM (SRAM), dynamic RAM (DRAM), synchronous DRAM (SDRAM), double data rate SDRAM (DDRSDRAM), enhanced SDRAM (ESDRAM), synchronous chain Channel (Synchlink) DRAM (SLDRAM), memory bus (Rambus) direct RAM (RDRAM), direct memory bus dynamic RAM (DRDRAM), and memory bus dynamic RAM (RDRAM), etc.

It should be noted that in this article, relational terms such as “first” and “second” are only used to distinguish one entity or operation from another entity or operation, and without necessarily requiring or implying any such actual relationship or order between these entities or operations. Moreover, the terms “including”, “containing” or any other variants thereof are intended to cover non-exclusive inclusion, so that a process, method, article, or device that comprises a series of elements comprises not only those elements, but also those that are not explicitly listed other elements of, or also include elements inherent to this process, method, article or equipment. Without more restrictions, the element defined by the sentence “including a . . . ” does not exclude the existence of other identical elements in the process, method, article, or equipment that comprises the element.

The above are only specific implementations of the present disclosure to enable those skilled in the art to understand or implement the present disclosure. Various modifications to these embodiments will be obvious to those skilled in the art, and the general principles defined herein can be implemented in other embodiments without departing from the spirit or scope of the present disclosure. Therefore, the present disclosure will not be limited to the embodiments shown in this document, but should conform to the widest scope consistent with the principles and novel features disclosed in this document.

1. An interface interaction method, applied to a terminal, comprising:
receiving a page switching instruction of a current page, the page switching instruction carrying a page identifier of a next page, the current page comprising a background layer and a content layer located above the background layer;
executing the page switching instruction, displaying the next page; and
receiving a first preset instruction configured to operate the next page when the next page only comprises the background layer, and executing the first preset instruction.

2. The method of claim 1, further comprising:
receiving a second preset instruction configured to operate the next page when the next page only comprises the content layer, and executing the second preset instruction, the content layer comprising at least one content classification module.

3. The method of claim 1, further comprising:
receiving a third preset instruction configured to operate the content layer when the next page comprises the content layer and the background layer, and executing the third preset instruction, the content layer comprising at least one function classification module.

4. The method of claim 1, wherein when the next page only comprises the background layer, the first preset instruction comprises a background switching instruction, executing the first preset instruction comprises:
executing the background switching instruction, switching a background material in the background layer, wherein the background layer comprises at least two background materials.

5. The method of claim 1, wherein when the next page only comprises the background layer, the first preset instruction comprises a first control instruction, executing the first preset instruction comprises:
executing the first control instruction, and controlling a background material in the background layer.

6. The method of claim 1, further comprising:
determining whether a first current active page is the current page, wherein the first current active page is a page that is operated currently; and
receiving a return instruction when the first current active page is not the current page, and executing the return instruction configured to return the first current active page to the current page.

7. The method of claim 1, further comprising:
determining whether a second current display page is a preset page, wherein the second current display page is a page that is operated currently;
acquiring an execution time of a last operation instruction executed on the second current display page when the second current display page is the preset page; and
acquiring a current time, when a time difference between the current time and the execution time is equal to a preset time difference, generating a first play instruction configured to play the background material, and executing the first play instruction.

8. The method according to claim 7, wherein the background material comprises a plurality of recommending data, each of the recommending data carries at least one data tag, and each of the data tag corresponds to a function classification module.

9. An interface interaction apparatus, comprising:
a switching instruction receiving module configured to receive a page switching instruction of a current page, the page switching instruction carrying a page identifier of a next page, the current page comprising a background layer and a content layer located above the background layer;
a switching instruction execution module configured to execute the page switching instruction and display the next page; and
a first execution operation module, configured to receive a first preset instruction configured to operate the next page when the next page only comprises the background layer and execute the first preset instruction.

10. A computer device, comprising: a memory, a processor, and a computer program stored on the memory and capable of being running on the processor, wherein the processor implements the method of claim 1 when executing the computer program.

11. A computer-readable storage medium, with a computer program stored thereon, wherein the computer program implements the method of claim 1 when the computer program is executed by a processor.
